(19) United States
(12) Patent Application Publication
(10) Pub. No.: US 2026/0156665 A1
(43) Pub. Date: Jun. 4, 2026

(54) METHOD AND DEVICE FOR SCHEDULING AND POWER ALLOCATION IN MULTI-CPU CELL-FREE NETWORK

(71) Applicant: INDUSTRY-UNIVERSITY COOPERATION FOUNDATION HANYANG UNIVERSITY ERICA CAMPUS, Ansan-si, Gyeonggi-do (KR)

(72) Inventors: Sunghyun CHO, Ansan-si, Gyeonggi-do (KR); Soohyeong KIM, Ansan-si, Gyeonggi-do (KR); Seyoung AHA, Ansan-si, Gyeonggi-do (KR)

(73) Assignee: INDUSTRY-UNIVERSITY COOPERATION FOUNDATION HANYANG UNIVERSITY ERICA CAMPUS, Ansan-si, Gyeonggi-do (KR)

(21) Appl. No.: 19/384,557

(22) Filed: Nov. 10, 2025

Related U.S. Application Data
(63) Continuation of application No. PCT/KR2024/006062, filed on May 7, 2024.

(30) Foreign Application Priority Data
Oct. 5, 2023 (KR) 10-2023-0060617

(51) Int. Cl. H04W 72/541; H04B 17/336

(52) U.S. Cl. CPC H04W 72/541; H04B 17/336

(57) ABSTRACT

An operating method of an access point (AP) for performing scheduling and power allocation in a multi-central processing unit (CPU) cell-free network includes: receiving a reference signal from one or more user equipments (UEs), performing channel estimation based on the received reference signal, deriving a signal-to-leakage-interference-plus-noise-ratio (SLINR) for each of the one or more UEs based on the channel estimation, and performing the scheduling and the power allocation based on the derived SLINR.

### CROSS-REFERENCE TO RELATED APPLICATION

This application is a bypass continuation of pending PCT International Application No. PCT/KR2024/006062, which was filed on May 7, 2024, and which claims priority to and the benefit of Korean Patent Application No. 10-2023-0060617, filed on May 10, 2023, in the Korean Intellectual Property Office, the disclosure of which is incorporated herein by reference in its entirety.

### BACKGROUND

### 1. Field of the Invention

The present disclosure relates to a method and device for performing scheduling and power allocation in a multi-central processing unit (CPU) cell-free network. Specifically, the present disclosure relates to a method and device for performing scheduling and power allocation in a distributed form at a plurality of access points (APs) distributed in a large area based on multiple CPUs.

### 2. Discussion of Related Art

In next-generation mobile communication systems, a higher frequency band is considered to satisfy requirements such as an enhanced mobile broadband (eMBB) service. A fifth generation (5G) mobile communication system uses the millimeter wave (mmWave) band, and sixth generation (6G) is expected to use the terahertz (Thz) band in the future. Since a wide bandwidth is present in a high frequency band, a faster transmission speed can be supported. Therefore, eMBB service requirements may be satisfied, and services such as augmented reality (AR) and virtual reality (VR) may be easily supported in the future. However, due to the physical characteristics of the high frequency band, the propagation environment is degraded, and the size of a cell supported by a base station may gradually decrease. In addition, a problem of an intensified inter-cell interference (ICI) effect at a cell-edge occurs. A cell-free system may be considered to overcome the ICI problem due to ultra-high frequency band utilization and cell miniaturization, and a method of performing scheduling and power allocation in a multi-CPU-based cell-free network will be described below.

Examples of related art include PCT international publication number WO/2023/037242A1.

### SUMMARY

The present disclosure is directed to providing a method and device for performing scheduling and power allocation in an access point (AP) distributed manner in a multi-central processing unit (CPU) cell-free network.

The present disclosure is also directed to providing a method and device for performing scheduling and power allocation at a plurality of APs distributed in a large area based on multiple CPUs.

The present disclosure is also directed to providing a method and device for performing scheduling and power allocation to improve the performance of user equipments (UEs) located in a CPU-edge area and overall network performance.

The present disclosure is also directed to providing a method and device for performing scheduling using an auction-based algorithm based on a signal-to-leakage-interference-plus-noise-ratio (SLINR).

The present disclosure is also directed to providing a method and device for performing scheduling based on an auction-based algorithm and performing power allocation based on a power allocation algorithm.

According to an aspect of the present disclosure, there is provided an operating method of an AP for performing scheduling and power allocation in a multi-CPU cell-free network, the operating method including receiving a reference signal from one or more UEs, performing channel estimation based on the received reference signal, deriving a signal-to-leakage-interference-plus-noise-ratio (SLINR) for each of the one or more UEs based on the channel estimation, and performing the scheduling and the power allocation based on the derived SLINR.

According to another aspect of the present disclosure, there is provided an operating method of a UE for performing scheduling in a multi-CPU cell-free network, which includes transmitting a reference signal to an AP, the AP receiving the reference signal from one or more UEs to perform channel estimation, deriving a SLINR for each of the one or more UEs based on the channel estimation, and performing scheduling and power allocation based on the derived SLINR, receiving bidding information from each of one or more APs including the AP when the scheduling is performed by the AP, and determining an AP set with which to perform communication based on the bidding information received from each of the one or more APs.

According to another aspect of the present disclosure, there is provided an AP for performing scheduling and power allocation in a multi-CPU cell-free network, which includes a memory, a transceiver, and a controller configured to control the memory and the transceiver, wherein the controller controls the transceiver to receive a reference signal from one or more UEs, performs channel estimation based on the received reference signal, derives a SLINR for each of the one or more UEs based on the channel estimation, and performs the scheduling and the power allocation based on the derived SLINR.

According to another aspect of the present disclosure, there is provided a UE for performing scheduling in a multi-CPU cell-free network, the UE includes a memory, a transceiver, and a controller configured to control the memory and the transceiver, in which the controller controls the transceiver to transmit a reference signal to an AP, the AP receiving the reference signal from one or more UEs to perform channel estimation, deriving a SLINR for each of the one or more UEs based on the channel estimation, and performing the scheduling and the power allocation based on the derived SLINR, controls the transceiver to receive bidding information from each of one or more APs including the AP when the scheduling is performed by the AP, and determines an AP set with which to perform communication based on the bidding information received from each of the one or more APs.

In addition, the following matters may be applied in common.

According to an embodiment of the present disclosure, the multi-CPU cell-free network may include a plurality of CPUs, and one or more APs may be connected to each of the plurality of CPUs based on a fronthaul.

According to an embodiment of the present disclosure, a UE located in a CPU internal area among the one or more UEs may communicate with a plurality of APs connected to any one CPU among the plurality of CPUs, and a UE located in a CPU edge area among the one or more UEs may communicate with a plurality of APs connected to each of the plurality of CPUs.

In addition, according to an embodiment of the present disclosure, the AP may perform initial scheduling and initial power allocation through the derived SLINR, and when the initial scheduling and the initial power allocation are performed, the AP may determine an initial scheduling UE set based on a large scale fading coefficient and allocate the same power for each UE in the initial scheduling UE set.

According to an embodiment of the present disclosure, the scheduling may be performed based on an auction-based algorithm after the initial scheduling and the initial power allocation are performed, power allocation may be performed based on a power allocation algorithm, and the scheduling and the power allocation may be repeated until an entire algorithm converges to a final value, and when the scheduling is performed based on the auction-based algorithm, the AP may transmit bidding information determined based on a power amount allocated for the UE and leakage amount information derived through the SLINR to the UE, the UE may acquire bidding information from each of a plurality of APs and determine a set of one or more APs with which to perform communication to perform the scheduling.

In addition, according to an embodiment of the present disclosure, when a set of UEs supported by the AP is determined based on the scheduling, the AP may perform the power allocation to maximize performance of a UE having the lowest performance among one or more UEs included in the set of UEs.

In addition, according to an embodiment of the present disclosure, the scheduling and the power allocation may be repeated until performance of the UE having the lowest performance converges to the final value at which the performance is maximized based on the entire algorithm.

In addition, according to an embodiment of the present disclosure, the bidding information may be determined based on a power amount allocated for the UE and leakage amount information derived through the SLINR.

In addition, according to an embodiment of the present disclosure, the multi-CPU cell-free network may include a plurality of CPUs, one or more APs are connected to each of the plurality of CPUs based on a fronthaul, and when the UE is located in a CPU internal area, the UE may communicate with a plurality of APs connected to any one CPU of the plurality of CPUs, and when the UE is located in a CPU edge area, the UE may communicate with a plurality of APs connected to each of the plurality of CPUs.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a network environment applied to the present disclosure;

FIG. 2 is a diagram illustrating a device configuration applied to the present disclosure;

FIG. 3 is a diagram illustrating a multi-central processing unit (CPU) cell-free network applied to the present disclosure;

FIG. 4 is a diagram illustrating a frame structure applied to the present disclosure;

FIG. 5 is a flowchart illustrating scheduling and transmission power methods applied to the present disclosure;

FIG. 6 is a flowchart illustrating scheduling and transmission power methods of an access point (AP) in a multi-CPU cell-free network applied to the present disclosure; and

FIG. 7 is a flowchart illustrating scheduling and transmission power methods of a UE in a multi-CPU cell-free network applied to the present disclosure.

### DETAILED DESCRIPTION OF EXEMPLARY EMBODIMENTS

Hereinafter, exemplary embodiments according to the present invention will be described in detail with reference to the accompanying drawings. The detailed description which will be described below in conjunction with the accompanying drawings is intended to describe exemplary embodiments of the present invention and is not intended to represent the only embodiment in which the present invention may be practiced. The following detailed description includes specific details to provide a thorough understanding of the present invention. However, those skilled in the art know that the present invention may be practiced without these specific details.

The following embodiments are those in which components and features of the present invention are combined in a predetermined form. Each component or feature may be considered to be optional unless otherwise explicitly stated. Each component or feature may be implemented in a form that is not combined with other components or features. In addition, some components and/or features may be combined to constitute an embodiment of the present invention. The order of the operations described in the embodiments of the present invention may be changed. Some configurations or features of any embodiment may be included in other embodiments or may be replaced with corresponding configurations or features of other embodiments.

Specific terms used in the following description are provided to help understanding of the present invention, and the use of such specific terms may be changed to other forms without departing from the technical spirit of the present invention.

In some cases, in order to avoid obscuring the concept of the present invention, well-known structures and devices are omitted or are illustrated in the form of a block diagram focusing on core functions of each structure and device. In addition, throughout the present disclosure, the same components will be described using the same reference numerals.

In addition, in the present disclosure, terms such as “first” and/or “second” may be used to describe various components, but these components should not be limited by these terms. The terms are used only for the purpose of distinguishing one component from another component, for example, without departing from the scope of rights according to the concept of the present disclosure, a first component may be referred to as a second component, and similarly, a second component may be referred to as a first component.

In addition, throughout the disclosure, when a part is referred to as “including” a component, it means that the part may further include other components rather than excluding other components, unless otherwise described. In addition, terms such as “unit” and “part” described in the disclosure mean a unit for processing at least one function or operation, which may be implemented by a combination of hardware and/or software.

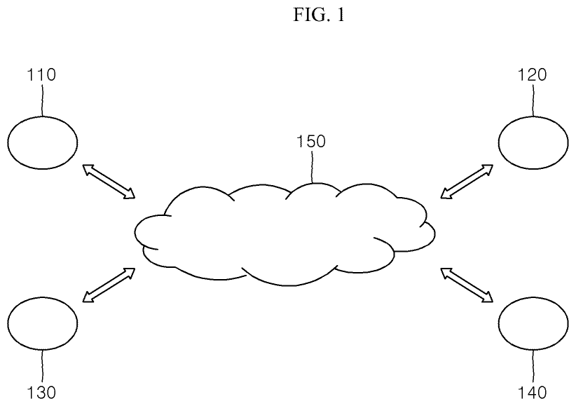

FIG. 1 is a diagram illustrating a network environment applied to the present disclosure.

Referring to FIG. 1, devices 110, 120, 130, and 140 may be connected through a network 150. As an example, the devices 110, 120, 130, and 140 may be connected to one or more devices or servers through the wireless network 150 and may transmit and receive data through this connection. In addition, the devices 110, 120, 130, and 140 or a user equipment (UE) may each be a mobile device or a fixed device. Specifically, the devices 110, 120, 130, and 140 may be mobile devices such as smartphones, tablets, or wearable devices. In addition, the devices 110, 120, 130, and 140 may be fixed devices such as computers, notebook computers, and personal computers (PCs). As another example, the devices 110, 120, 130, and 140 may be Internet of things (IoT) devices, virtual reality (VR)/augmented reality (AR) devices, and other devices and are not limited to specific embodiments.

In addition, the server may be a device having a function of providing content or a service by being connected to one or more devices through the network 150. As a specific example, the server may provide a service or provide a response according to a request to one or more devices connected through the network 150. Here, the server may be linked with one or more devices based on software or an application installed in each of the one or more devices and may provide a service through this linkage.

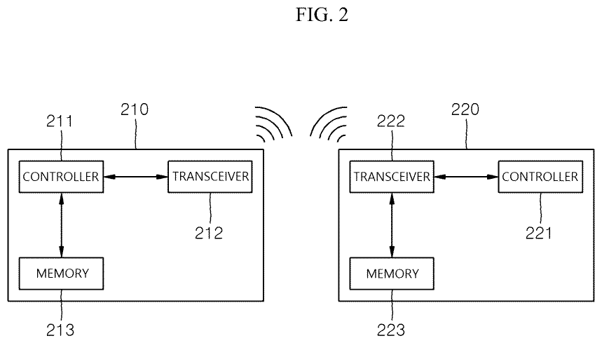

FIG. 2 is a diagram illustrating a configuration of a device applied to the present disclosure. Referring to FIG. 2, a device 210 may include a controller 211, a transceiver 212, and a memory 213. In addition, the device 210 may further include components other than the above-described components. The device 210 of FIG. 2 may transmit and receive data through communication with another device 220 and may be a UE. As an example, the device 210 may be a smartphone, a smart pad, a notebook computer, a PC, or another device capable of communication but may not be limited to a specific device.

As an example, the controller 211 of the device 210 may be configured to execute and process instructions related to driving or operation of the device 210. The controller 211 may be a logical entity that controls the transceiver 212 and other components but is not limited to a specific embodiment. The controller 211 of the device 210 may be configured to process instructions of a computer program by performing arithmetic, logic, and input/output operations. As an example, an instruction may be stored in the memory 213 or provided to the controller 211 based on a signal obtained through the transceiver 212, and the controller 211 may perform an operation based on the instruction.

The transceiver 212 may provide a function for communicating with at least one of the other device 220 and the server through a network. As an example, the other device 220 may also include a control unit 221, a transceiver 222, and a memory 223. In addition, the other device 220 may also be the above-described smart device, PC, or any communication-capable device and is not limited to a specific embodiment.

In addition, as an example, the device 210 may include an input unit (not shown) and an output unit (not shown). Here, the input unit may be a keyboard, a mouse, a touch pad, a camera, or any component that provides an input signal, and the output unit may be a display, a speaker, or any component that provides an output signal. However, the input unit and the output unit may not be limited thereto. An external output device may include devices such as a display, a speaker, a haptic feedback device, and the like.

The memory 213 is a non-transitory computer-readable recording medium and may include a permanent mass storage device such as a random access memory (RAM), a read only memory (ROM), a disk drive, a solid state drive (SSD), and a flash memory but is not limited to a specific form. In addition, the memory 213 may store instructions or program codes related to driving or operation of the device 210. In addition, the memory 213 may store an operating system or other software of the device 210. In addition, as an example, the device 210 may use software loaded from a separate computer-readable recording medium. Here, the computer-readable recording medium may include a floppy drive, a disk, a tape, a digital versatile disc (DVD)/compact disc (CD)-ROM drive, a memory card, and other recording media, but is not limited to a specific embodiment.

Hereinafter, the devices 210 and 220 of FIG. 2 will be described based on a UE. As an example, the UE may perform communication with a base station, an access point (AP), a transmission reception point (TRP), a node, and other devices based on the network of FIG. 1 and may not be limited to a specific embodiment.

As an example, the UE may communicate with the base station based on an existing mobile communication system. However, in the next-generation wireless communication system, the UE may perform communication through a high frequency band based on a new mobile communication system in consideration of eMBB requirements and communicate with a plurality of APs configured based on the new mobile communication system. Here, the AP may be an entity connected to a CPU and performing wireless communication with the UE, and may be a TRP, a node, a base station, and other components, but description will be made based on the AP for convenience of description below.

As an example, cell-free may be a technology for distributing a plurality of APs connected to one CPU over a large area and supporting the UE based on cooperation of the plurality of APs. That is, in the cell-free network, the UE may perform data transmission and reception by performing communication with a plurality of APs. As an example, in an existing mobile communication system, a UE may communicate with one base station within a cell coverage configured by a base station. On the other hand, the cell-free network may be different from a network that supports only the UE within the base station range like the existing base station-based cell structure. That is, since the plurality of APs simultaneously support the UE, the cell concept may be abandoned, and the network may thus be referred to as a cell-free network. However, the cell-free network is only one name, and it may not be limited thereto. That is, it may be equally applied to a network in which the plurality of APs simultaneously support the UE, and it will be referred to as a cell-free network for convenience of description below.

Here, in the high frequency (or ultra-high frequency) band, the size of the cell may be small, and performance reduction may occur due to the ICI problem described above, but in the cell-free network, since the plurality of APs simultaneously support the UE, the corresponding problem may be solved. As an example, even in an existing wireless communication system (e.g., LTE), a technology for increasing throughput through coordinated multi-point (CoMP) and network multi-input multi-output (network MIMO) has also been applied as a cooperative transmission technology. However, when transmission is performed through a plurality of transmission points based on CoMP, synchronization between the transmission points is problematic, and there may be a limitation on scalability. On the other hand, in the cell-free network, since a plurality of APs connected to one CPU may be installed in a wide range, there is an advantage that stable performance may be provided to the UE. For example, the cell-free network may be a network that considers only a single CPU, with a plurality of APs connected to the single CPU.

In a single CPU cell-free network architecture, since one CPU collects and processes all of the information of all APs and all UEs, optimal performance can be achieved. However, since the single CPU cell-free network architecture is based on one CPU, the computational complexity may exponentially increase as the number of APs increases or the number of UEs increases. Considering the above-described points, the problem of scalability may occur in the cell-free network.

Hereinafter, a method of performing communication based on a multi-CPU cell-free network will be described in consideration of the above-described points. More specifically, a method of performing scheduling and power allocation in the multi-CPU cell-free network will be described.

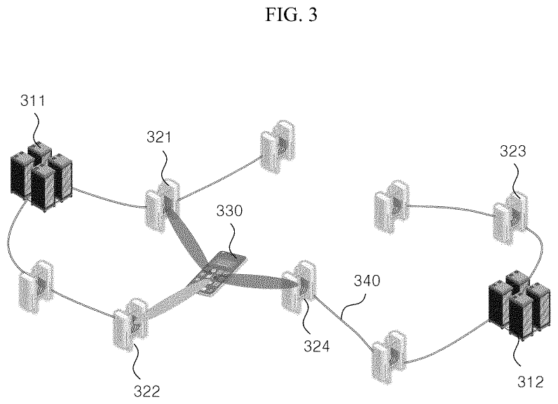

FIG. 3 is a diagram illustrating a multi-CPU cell-free network applied to the present disclosure. The multi-CPU cell-free network may have a structure in which a plurality of CPUs are disposed. As an example, in FIG. 3, two CPUs 311 and 312 are considered, but this is only one example and may not be limited thereto. Here, a plurality of APs may be distributed and connected to the CPUs, and accordingly, the computational complexity may be reduced, thereby solving the scalability problem. As an example, referring to FIG. 3, the CPU 311 connected to some APs 321 and 322 and the CPU 312 connected to some other APs 323 and 324 may be different from each other, and thus the computational complexity may be reduced.

However, in the multi-CPU cell-free network, since the number of APs connected to each CPU is reduced, the CPU radius, which is a range that one CPU can support, may be reduced. When the CPU radius is reduced, a CPU edge area may increase. Here, since a plurality of APs exist around the UE in a CPU area and support the UE, performance may be corrected, but, since the number of APs surrounding and supporting the UE around the UE is reduced in the CPU edge area, the performance reduction may occur like an existing cell-edge. Here, it is possible to solve the problem of performance reduction in the CPU edge area based on a plurality of CPU cooperation schemes. That is, in FIG. 3, a UE 330 is located in the edge area of each of the CPUs 311 and 312, but each of the APs 321, 322, and 324 supports the UE located at the CPU edge in a distributed manner, thereby solving the problem of performance reduction.

As an example, when information between CPUs is shared by a plurality of CPU cooperation schemes, higher performance may be supported. However, as in a problem of a single CPU cell-free network, a scalability problem due to an increase in computational complexity may occur again. Considering the above-described points, there may be a need for a scheme of solving the performance reduction problem by supporting the UE in the CPU edge area in a distributed manner in the APs. When the AP distributed support scheme is used to support the UE in the CPU edge area, when the APs transmit a signal to support all UEs in the CPU edge area, the UE may receive a signal from each of a plurality of APs, and interference may occur due to the corresponding signals, leading to degraded performance.

Therefore, when the AP distributed support scheme is used to support the UE in the CPU edge area, there may be a need for a scheme for controlling interference, and scheduling and power allocation methods for this may be required. As an example, scheduling may be a technique for determining how each AP supports a UE. Then, a technique for determining the strength of power to support the scheduled UEs may be a power allocation scheme.

As an example, in a multi-CPU cell-free network, a plurality of APs may simultaneously transmit data to the UE. Here, the scheduling may be a process of determining which APs perform transmission for a specific UE. Since the UE performs scheduling by an operation of bundling one or more APs to support the UE, the scheduling may also be referred to as AP clustering but is not limited to the corresponding name. In addition, when scheduling is completed, power may be determined based on a power allocation method related to data transmission.

As a specific example, referring to FIG. 3, the UE 330 may perform communication by scheduling a plurality of APs based on a multi-CPU cell-free network. Here, the first AP 321 may be connected to the first CPU 311 through a fronthaul, and the first AP 321 may be scheduled for communication with the UE 330. On the other hand, the second AP 322 may be connected to the first CPU 311 through the fronthaul but may not be scheduled for communication with the UE 330. In addition, a third AP 324 may be connected to the second CPU 312 through a fronthaul 340, and the third AP 324 may be scheduled with the UE 330. That is, the UE 330 may perform data transmission by selecting the first AP 321 and the third AP 324.

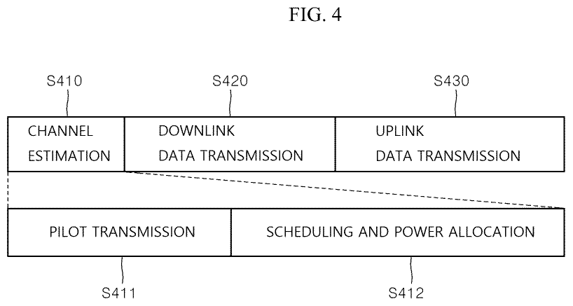

FIG. 4 is a diagram illustrating a frame structure applied to the present disclosure. Referring to FIG. 4, the frame may include a channel estimation operation S410, a downlink data transmission operation S420, and an uplink data transmission operation S430. That is, the UE may check the channel through the channel estimation operation S410, perform scheduling and power allocation, and then receive or transmit data through the connected APs.

Specifically, the channel estimation operation S410 may include an operation S411 of transmitting a reference signal (pilot) and an operation S412 of performing scheduling and power allocation. As an example, in the channel estimation operation S410, the UE may transmit an allocated reference signal to the AP. The AP may perform channel estimation through the reference signal received from the UE. Here, a minimum mean square error (MMSE) scheme may be used for the channel estimation.

More specifically, in a single CPU cell-free network, since all APs are connected to one CPU, it is possible to derive an optimal policy by sharing all information during scheduling and power allocation. On the other hand, in a multi-CPU cell-free network, information sharing may only be possible between APs connected to each CPU. That is, the information of the AP connected to another CPU cannot be recognized. Therefore, the AP cannot predict how much interference will occur according to the scheduling and power allocation policy of the AP connected to the other CPU and cannot use a signal-to-interference-plus-noise-ratio (SINR) as a performance indicator for controlling interference. As an example, when interference is not controlled, performance degradation may occur in a CPU edge area like an existing cell-based network even in a multi-CPU cell-free network. Here, in order to solve the interference control problem, a method of cooperatively supporting the UE by sharing all information between the CPUs may be used, but in this case, the computational complexity rapidly increases, and thus the scalability problem occurs again.

In consideration of the above-described points, in the following, it is intended to provide scheduling and power allocation methods operating in a distributed manner at the APs. The distributed scheduling and power allocation technique may be a method in which scheduling and power allocation are independently performed at each AP without sharing information. Since the distributed scheduling and power allocation technique is independently performed at each AP, it may be free from the scalability problem, but interference information may not be identified and thus an interference problem may occur.

As an example, when a specific AP supports scheduled UEs, the AP may utilize an interference amount generated between the corresponding UEs and an interference amount applied to UEs other than the scheduled UEs for interference control. As an example, the interference amount applied to UEs other than the scheduled UEs may be a leakage amount. The AP may perform SINR-based scheduling and power allocation in consideration of the leakage amount. That is, the AP may perform scheduling and power allocation by calculating an SINR. By doing so, the AP may reduce the interference amount between scheduled UEs and suppress the leakage amount generated to other UEs. Through this, it is possible to improve the overall network performance while preventing UE performance degradation in the CPU edge area without sharing information between APs connected to other CPUs.

As a specific example, when AP^{m} supports UE^{k}, SLINR may be expressed as in Expression 1 below. In Expression 1, DS_{m,k} denotes a desired signal, BU_{m,k} denotes a beamforming uncertainty, UI_{m,k,k′} denotes user-interference from a UE in the same CPU, and L_{m,k,k′} denotes a leakage amount to another CPU UE. In addition, ρ_{m,k} denotes a transmission power amount at the AP, h_{m,k} denotes a channel between the AP and the UE, and w_{m,k} denotes a beamforming vector.

$${SLINR}_{m , k} = \frac{{\vert {DS}_{m , k} \vert}^{2}}{\begin{matrix}E \{ {\vert {BU}_{m , k} \vert}^{2} \} + {\sum }_{{k}^{′} ∈ {𝒰}_{m} \backslash \{ k \}} E \{ {\vert {UI}_{m , k , {k}^{′}} \vert}^{2} \} + \\ {\sum }_{{k}^{′} ∈ 𝒦 \backslash {𝒰}_{m}} E \{ {\vert {L}_{m , k , {k}^{′}} \vert}^{2} \} + 1\end{matrix}} \qquad [ Expression 1 ]$$

$${DS}_{m , k} = \sqrt{{ρ}_{m , k}} E \{ {h}_{m , k}^{H} {w}_{m , k} \}$$

$${BU}_{m , k} = \sqrt{{ρ}_{m , k}} ( {h}_{m , k}^{H} {w}_{m , k} - E \{ {h}_{m , k}^{H} {w}_{m , k} \} )$$

$${UI}_{m , k , {k}^{′}} = \sqrt{{ρ}_{m , {k}^{′}}} {h}_{m , k}^{H} {w}_{m , {k}^{′}}$$

$${L}_{m , k , {k}^{′}} = \sqrt{{ρ}_{m , k}} {h}_{m , {k}^{′}}^{H} {w}_{m , k}$$

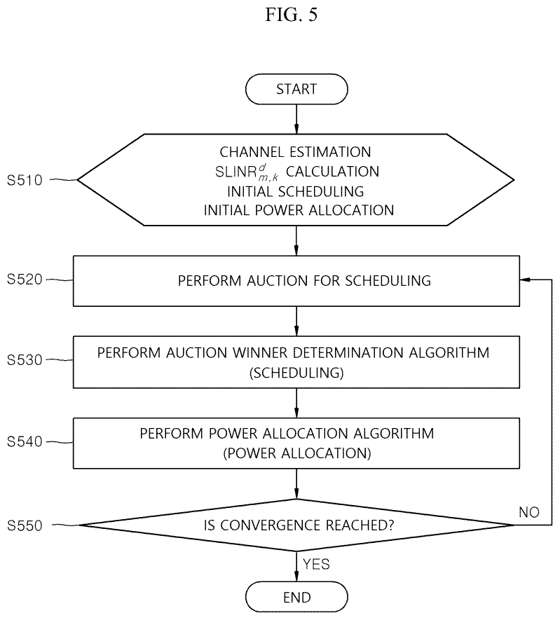

As described above, the AP may derive the SLINR in consideration of the leakage amount to perform scheduling and power allocation. As a specific example, FIG. 5 is a diagram illustrating scheduling and transmission power methods applied to the present disclosure. Referring to FIG. 5, the AP may perform channel estimation, calculate SLINR_{m,k} based on Expression 1, and then perform initial scheduling and power allocation (S510). Here, the initial scheduling may be performed by each AP^{m} in consideration of a large-scale fading coefficient β_{m,k} between UE^{k} and AP^{m}. For example, when β_{m,k} for UE^{k} is greater than a specific threshold βₜₕ in each AP^{m}, the UE may be scheduled to be included in each AP^{m}.

In addition, when an initial scheduling UE set configured by the AP^{m} is [symbol] ₘ, the initial power allocation may be equally configured for each UE based on Expression 2 below.

$${ρ}_{m , k} = \frac{{ρ}_{max}}{\vert {𝒰}_{m} \vert} \qquad [ Expression 2 ]$$

Here, when scheduling and power allocation are simultaneously performed, there may be a limitation in simultaneous resolution due to a non-deterministic polynomial (NP)-hard combination optimization problem. For example, the NP problem may be a non-deterministic algorithm that needs to simultaneously consider a plurality of possibilities in each operation of solving the problem and may be solved according to the plurality of possibilities when scheduling and power allocation are simultaneously performed. In consideration of the above-described points, the AP may be optimized while performing the power allocation (S540) after performing the scheduling (S520 and S530), and the corresponding operation may be repeated until convergence is achieved.

### Scheduling Policy Determination Method

As described above, since there is a limitation on simultaneously performing scheduling and power allocation, the AP may perform scheduling first and then perform power allocation. Here, scheduling may be a problem of determining which UE each AP supports among a plurality of UEs. In addition, the UE also needs to determine which AP to select among the plurality of APs. That is, each AP may simultaneously support the plurality of UEs, and each UE may also be simultaneously supported by the plurality of APs.

When scheduling is performed in consideration of the above-described points, the scheduling may be performed based on an overlapping coalition formation game (OCFG) scheme. The OCFG scheme may involve forming a coalition for each game player to process a specific task. Here, the player may simultaneously belong to multiple coalitions and contribute different amounts of resources to each of the participating coalitions, and contribution levels may be distributed among the players. Each coalition has a value according to the invested resources, and all players may determine in which coalition to participate and how many resources to invest in order to maximize the value of the coalitions to which they belong.

As an example, the above-described OCFG scheme may be introduced into the scheduling. Specifically, in an environment in which a plurality of APs and a plurality of UEs coexist, an OCFC scheme may be considered to support a specific UE by each AP. Here, each AP may correspond to a game player in the OCFG scheme. In addition, a plurality of APs may be selected to perform communication with a specific UE. Here, the plurality of APs may form a coalition to perform work as communication with a specific UE. In addition, the plurality of APs may support communication of another specific UE other than the specific UE. That is, each of the APs may belong to a plurality of coalitions. That is, a scheduling operation for the plurality of APs and the plurality of UEs in a multi-CPU cell-free network may correspond to the OCFG scheme.

Here, an optimal solution may be determined by each AP based on the OCFG scheme, and accordingly, a scheduling operation may be performed. To this end, each AP needs to accurately recognize a value of a coalition (i.e., a support operation for a specific UE), and to this end, it may be preferable to share scheduling information between all APs. However, the above-described method needs to be performed every frame, and accordingly, it may not be suitable because a huge information sharing load is generated.

In consideration of the above-described points, the scheduling may be performed based on an auction-based scheduling algorithm (S520). Here, the auction may be a decision-making method in which a plurality of bidders submit bids to an auctioneer, and the auctioneer determines a bidder who presents the highest bid among the plurality of bids as a winner of the auction (S520). As an example, an auction-based scheduling algorithm method may be applied to a multi-CPU cell-free network. More specifically, in the multi-CPU cell-free network, each AP may be a bidder of the auction-based scheduling algorithm, and the UE may be an auctioneer. Here, based on the auction-based scheduling algorithm method, each of the APs may submit bids to the UE and then determine the winners of the auction so that the UE forms a coalition having the highest value. As an example, for convenience of description, the above-described scheduling is referred to as auction-based scheduling but may not be limited thereto. That is, the specific UE may perform scheduling so that the highest result is derived based on each AP but may not be limited to the corresponding name. Based on the above description, an optimal scheduling policy may be derived while the information sharing load is significantly reduced.

Here, the value of the coalition may be determined based on the signal strength received by the specific UE and the leakage amount to other UEs. As an example, a specific UE may be assigned a higher value when the received signal strength is greater and the leakage amount to other UEs is smaller. Therefore, the bid that each AP submits to the UEs may be the power amount allocated using resources invested to the coalition for the specific UE and the leakage amount at that time. As an example, the bid that AP^{m} submits to UE^{k} may be expressed as in Expression 3.

$${Bid}_{m , k} = ( {ρ}_{m , k} , {\sum }_{{k}^{′} ∈ 𝒦 \backslash {𝒰}_{m}} E \{ {\vert {L}_{m , k , {k}^{′}} \vert}^{2} \} ) \qquad [ Expression 3 ]$$

Here, the UE^{k} may derive the value of the coalition for the UE^{k} using the received bids. A value function of the coalition may be determined by a power intensity ρₖ and a scheduling policy determiner Λₖ and may be expressed as in Expression 4.

$$v ( {ρ}_{k} , {Λ}_{k} ) = \frac{{\sum }_{m ∈ {𝒞}_{k}} {( \sqrt{{ρ}_{m , k}} E \{ {h}_{m , k}^{H} {w}_{m , k} \} )}^{2} {λ}_{m , k}}{{\sum }_{m ∈ {𝒞}_{k}} {\sum }_{{k}^{′} ∈ 𝒦 \backslash {𝒰}_{m}} E \{ {\vert {L}_{m , k , {k}^{′}} \vert}^{2} \} {λ}_{m , k} + 1} \qquad [ Expression 4 ]$$

Here, [symbol] ₖ is a set of APs that have sent bids, and λ_{m,k} is a scheduling policy decision maker and may have a value of 0 or 1. As an example, when λ_{m,k} is 0, it may mean that AP^{m} does not support UE^{k}, and when λ_{m,k} is 1, it may mean that the AP^{m} supports the UE^{k}.

The UE may increase the value function by combining λ_{m,k} using the collected bids. That is, each UE may derive an optimal scheduling policy by solving the problem of finding a combination of λ_{m,k} which maximizes the value of the coalition. The optimization problem of maximizing the value of the coalition may be expressed as in Expression 5.

$$arg {max}_{{Λ}_{k}} v ( {ρ}_{k} , {Λ}_{k} ) \qquad [ Expression 5 ]$$

$$s . t . {λ}_{m , k} ∈ \{ 0 , 1 \} , ∀ m ∈ ℳ .$$

Here, the value optimization problem of the coalition may be transformed into mixed integer fractional programming as expressed in Expression 6 below.

$$arg {max}_{u , {G}_{k}} {\sum }_{m ∈ {𝒞}_{k}} {( \sqrt{{ρ}_{m , k}} E \{ {h}_{m , k}^{H} {w}_{m , k} \} )}^{2} {g}_{m , k} \qquad [ Expression 6 ]$$

$$s . t . u + {\sum }_{m ∈ {𝒞}_{k}} {\sum }_{{k}^{′} ∈ 𝒦 \backslash {𝒰}_{m}} E \{ {\vert {L}_{m , k , {k}^{′}} \vert}^{2} \} {g}_{m , k} = 1$$

$$u - M ( 1 - {λ}_{m , k} ) \leq {g}_{m , k} \leq min ( u , M {λ}_{m , k} )$$

$$u \geq 0$$

$${λ}_{m , k} ∈ \{ 0 , 1 \} , ∀ m ∈ ℳ$$

In Expression 6, u=1/(Σ_{meC}_{ₖ}Σ_{k′eX\u}_{ₘ}E{|L_{m,k,k′}|²}λ_{m,k}+1) and g_{m,k}=λ_{m,k}·u. Based on the above description, a solution may be derived from Expression 6 through CVX using the mixed integer fractional programming. As an example, the winner of the final auction ( [symbol] ₘ={k|λ_{m,k}=1}) may be determined by calculating λ_{m,k} based on the derived solution (u,Gₖ). In addition, the winner set [symbol] ₘ of the corresponding auction may be used as a scheduling policy (S530).

### Power Allocation Policy Determination Method

When the winner set uₘ n of the auction is derived based on the above-described auction-based scheduling, power may be allocated based on a power allocation algorithm (S540). Here, AP^{m} may determine how to distribute power to each UE of the derived scheduling policy [symbol] ₘ. As an example, as described above, when a UE is located in the CPU edge area, it is possible to consider improving the performance of the UE and overall network performance. To this end, a maximin method of maximizing the performance of the minimum performance UE may be used, which may be expressed as in Expression 7.

$${max}_{{ρ}_{m}} {min}_{k ∈ {𝒰}_{m}} {SLINR}_{m , k} \qquad [ Expression 7 ]$$

$$s . t . {\sum }_{k ∈ {𝒰}_{m}} {ρ}_{m , k} \leq {ρ}_{max}$$

$${ρ}_{m , k} \cdot \geq 0 , ∀ k ∈ {𝒰}_{m}$$

In this case, each AP may be optimized so that all UEs may have uniform performance by maximizing the performance of the lowest performance UE in the scheduling policy. Since the lowest performance UEs may be UEs located at the CPU edge, the performance of the UEs located at the CPU edge may also be improved. In addition, the maximin of Expression 7 may be transformed into a maximization problem based on Expression 8 below.

$${max}_{{ρ}_{m} , γ} γ \qquad [ Expression 8 ]$$

$$s . t . {SLINR}_{m , k} \geq γ , ∀ k ∈ {𝒰}_{m}$$

$${\sum }_{k ∈ {𝒰}_{m}} {ρ}_{m , k} \leq {ρ}_{max}$$

$${ρ}_{m , k} \cdot \geq 0 , ∀ k ∈ {𝒰}_{m}$$

Here, the first constraint is a problem of finding the largest γ, and this problem may be performed by finding the optimal γ through a bisection method. As an example, the maximization problem of Expression 8 may be derived by converting it into a feasibility problem as expressed in Expression 9 below.

$${min}_{{ρ}_{m}} 0 \qquad [ Expression 9 ]$$

$$s . t . {γ}_{candidate} \cdot {SLINR}_{m , k}^{denom} - {SLINR}_{m , k}^{numer} \leq 0 , ∀ k ∈ {𝒰}_{m}$$

$${\sum }_{k ∈ {𝒰}_{m}} {ρ}_{m , k} \leq {ρ}_{max}$$

$${ρ}_{m , k} \cdot \geq 0 , ∀ k ∈ {𝒰}_{m}$$

Here, γ_{candidate} is a value given through the bisection method,

$${SLINR}_{m , k}^{denom}$$

may be the denominator of Expression 1, and

$${SLINR}_{m , k}^{numer}$$

may be the numerator of Expression 1. That is, given γ_{candidate} derived through the bisection method, when even one combination of ρₘ that satisfies the constraints can be found, it can be a solution. Here, to find the optimal γ_{candidate}, γ_{lower}=0 may be set and γᵤₚₚₑᵣ may be set as expressed in Expression 10.

$${γ}_{upper} = {min}_{k ∈ {𝒰}_{m}} \frac{{\vert {DS}_{m , k} \vert}^{2}}{{\sum }_{{k}^{′} ∈ 𝒦 \backslash {𝒰}_{m}} E \{ {\vert {L}_{m , k , {k}^{′}} \vert}^{2} \} + 1} \qquad [ Expression 10 ]$$

Here, γᵤₚₚₑᵣ may mean the highest value that can be obtained when no AP^{m} supports any UE except when AP^{m}; supports UE^{k}. After that, it is defined as

$${γ}_{candidate} = \frac{{γ}_{lower} + {γ}_{upper}}{2}$$

and it is possible to search whether a ρₘ that satisfies Expression 9 is present using CVX. As an example, an optimal power allocation policy

$${ρ}_{m}^{opt}$$

can be updated to the newly searched ρₘ and the lower bound can be raised to γ_{lower}=γ_{candidate}. On the other hand, when such a combination is not present, the upper bound can be reduced to γᵤₚₚₑᵣ=γ_{candidate}. Here, when convergence reaches the extent that γᵤₚₚₑᵣ−γ_{lower}≤ϵ, the above-described process can be terminated, and the final power allocation policy can be derived (S550).

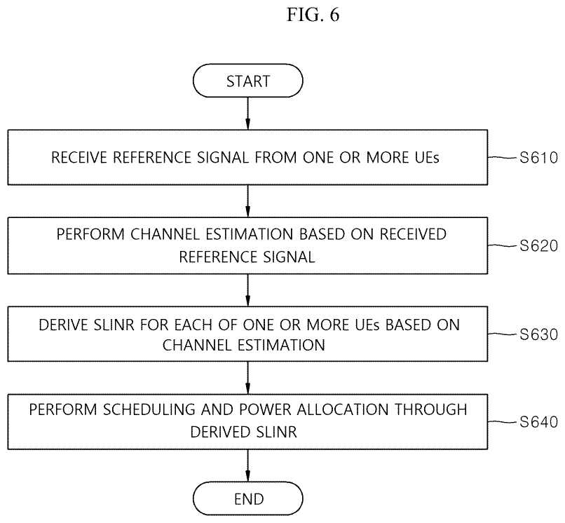

FIG. 6 is a flowchart illustrating scheduling and transmission power methods of an AP in a multi-CPU cell-free network applied to the present disclosure. Referring to FIG. 6, an AP for performing scheduling and power allocation in a multi-CPU cell-free network may receive a reference signal from one or more UEs (S610). Thereafter, the AP may perform channel estimation based on the received reference signal (S620) and derive an SLINR for each of the one or more UEs based on the channel estimation (S630). Thereafter, the AP may perform scheduling and power allocation based on the derived SLINR (S640).

Here, the multi-CPU cell-free network may include a plurality of CPUs, and one or more APs may be connected to each of the plurality of CPUs based on a fronthaul. In addition, a UE located in a CPU internal area among the one or more UEs may perform communication with a plurality of APs connected to any one CPU among a plurality of CPUs. On the other hand, a UE located in the CPU edge area among the one or more UEs may perform communication with the plurality of APs connected to each of the plurality of CPUs. That is, the UE located in the CPU edge area may perform communication with the plurality of APs based on the plurality of CPUs.

As an example, the AP may perform initial scheduling and initial power allocation through the derived SLINR. Here, when initial scheduling and initial power allocation are performed, the AP may determine an initial scheduling UE set based on a large scale fading coefficient and allocate the same power for each UE in the initial scheduling UE set, which is as described above.

Thereafter, scheduling may be performed based on an auction-based algorithm after the initial scheduling and the initial power allocation are performed. Thereafter, power allocation may be performed based on the power allocation algorithm, and scheduling and power allocation may be repeated until the entire algorithm converges to the final value. Here, as an example, when scheduling is performed based on the auction-based algorithm, the AP may transmit bidding information determined based on the power amount allocated for the UE and the leakage amount information derived through the SLINR to a specific UE. Here, the specific UE may perform scheduling by acquiring bidding information from each of the plurality of APs and determining a set of one or more APs with which to perform communication. In addition, a set of UEs supported by the AP may be determined based on the above description. Here, the AP may perform power allocation to maximize the performance of a UE having the lowest performance among one or more UEs included in the set of UEs. As an example, the above-described scheduling and power allocation may be repeated until the performance of the UE having the lowest performance converges to a final value at which the performance is maximized based on the entire algorithm, which is as described above.

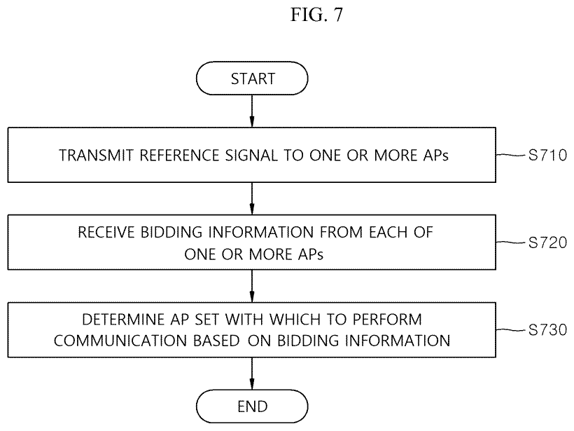

FIG. 7 is a flowchart illustrating scheduling and transmission power methods of a UE in a multi-CPU cell-free network applied to the present disclosure. Referring to FIG. 7, a UE may transmit a reference signal to one or more APs (S710). Here, each of one or more APs may perform channel estimation through the reference signal received from the UE and derive an SLINR for each of the UEs based on the channel estimation. Thereafter, the AP may perform scheduling and power allocation based on the derived SLINR.

When scheduling and power allocation are performed, the UE may receive bidding information from each of the one or more APs (S720). The UE may determine an AP set with which to perform communication based on the bidding information (S730). In addition, based on the above description, the set of UEs that the AP supports may be determined.

As an example, the multi-CPU cell-free network may include a plurality of CPUs, and one or more APs may be connected to each of the plurality of CPUs based on a fronthaul. In addition, the UE located in the CPU internal area among the one or more UEs may perform communication with a plurality of APs connected to any one CPU among the plurality of CPUs. On the other hand, the UE located in the CPU edge area among the one or more UEs may perform communication with the plurality of APs connected to each of the plurality of CPUs. That is, the UE located in the CPU edge area may perform communication with the plurality of APs based on the plurality of CPUs.

As an example, the AP may perform initial scheduling and initial power allocation through the derived SLINR. Here, when initial scheduling and initial power allocation are performed, the AP may determine an initial scheduling UE set based on a large scale fading coefficient and allocate the same power for each UE in the initial scheduling UE set, which is as described above.

Thereafter, scheduling may be performed based on an auction-based algorithm after the initial scheduling and the initial power allocation are performed. Thereafter, power allocation may be performed based on the power allocation algorithm, and scheduling and power allocation may be repeated until the entire algorithm converges to the final value. Here, as an example, when the scheduling is performed based on the auction-based algorithm, the AP may transmit bidding information determined based on the power amount allocated for the UE and the leakage amount information derived through the SLINR to a specific UE. Here, the specific UE may acquire bidding information from each of the plurality of APs and determine a set of one or more APs with which to perform communication. Thereby, scheduling is performed. In addition, a set of UEs supported by the AP may also be determined based on the above description. Here, the AP may perform power allocation to maximize the performance of the UE having the lowest performance among the one or more UEs included in the set of UEs. As an example, the above-described scheduling and power allocation may be repeated until the performance of the UE having the lowest performance converges to a final value at which the performance is maximized based on the entire algorithm, which is as described above.

The above-described embodiments of the present invention may be implemented through various means. For example, embodiments of the present invention may be implemented by hardware, firmware, software, or a combination thereof.

In the case of implementation by hardware, the method according to embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In the case of implementation by firmware or software, the method according to embodiments of the present invention may be implemented in the form of a module, procedure, function, or the like for performing the functions or operations described above. Software code may be stored in a memory unit and driven by a processor. The memory unit may be located inside or outside the processor and may transmit and receive data to and from the processor by various known means.

The present disclosure has an effect of efficiently performing communication in a high frequency band by performing scheduling and power allocation in an AP distributed manner in a multi-CPU cell-free network.

The present disclosure has an effect of providing a method of performing scheduling and power allocation at a plurality of APs distributed in a large area based on multiple CPUs.

The present disclosure has an effect of providing a method of performing scheduling and power allocation to improve the performance of UEs located in a CPU edge area and overall network performance.

The present disclosure has an effect of providing a method of performing scheduling using an auction-based algorithm based on an SLINR.

The present disclosure has an effect of providing a method of performing scheduling based on an auction-based algorithm and performing power allocation based on a power allocation algorithm.

The effects that can be obtained from the present disclosure are not limited to the above-mentioned effects, and other effects that are not mentioned may be clearly understood by those skilled in the art to which the present invention pertains from the description below.

The detailed description of exemplary embodiments of the present invention described above has been provided to enable those skilled in the art to implement and embody the present invention. Although the present invention has been described above with reference to the exemplary embodiments, it will be understood by those skilled in the art that various modifications and changes may be made to the present invention without departing from the spirit and scope of the present invention as set forth in the claims below. Accordingly, the present invention is not intended to be limited to the embodiments described herein but is to be accorded the broadest scope consistent with the principles and novel features disclosed herein. In addition, although the exemplary embodiments of the present disclosure have been illustrated and described above, the present disclosure is not limited to the specific embodiments described above, and various modifications may be made thereto by those skilled in the art to which the present invention pertains without departing from the gist of the present disclosure claimed in the claims, and such modifications should not be individually understood from the technical spirit or prospect of the present disclosure.

In addition, both the product invention and the method invention have been described in the present disclosure, and the description of both inventions may be supplementarily applied as needed.

What is claimed is:

1. An operating method of an access point (AP) for performing scheduling and power allocation in a multi-central processing unit (CPU) cell-free network, the operating method comprising:
receiving a reference signal from one or more user equipments (UEs);
performing channel estimation based on the received reference signal;
deriving a signal-to-leakage-interference-plus-noise-ratio (SLINR) for each of the one or more UEs based on the channel estimation; and
performing the scheduling and the power allocation based on the derived SLINR.

2. The operating method of claim 1, wherein the multi-CPU cell-free network includes a plurality of CPUs, and
one or more APs are connected to each of the plurality of CPUs based on a fronthaul.

3. The operating method of claim 2, wherein a UE located in a CPU internal area among the one or more UEs communicates with a plurality of APs connected to any one CPU among the plurality of CPUs, and
a UE located in a CPU edge area among the one or more UEs communicates with a plurality of APs connected to each of the plurality of CPUs.

4. The operating method of claim 1, wherein the AP performs initial scheduling and initial power allocation through the derived SLINR, and
when the initial scheduling and the initial power allocation are performed, the AP determines an initial scheduling UE set based on a large scale fading coefficient and allocates the same power for each UE in the initial scheduling UE set.

5. The operating method of claim 4, wherein the scheduling is performed based on an auction-based algorithm after the initial scheduling and the initial power allocation are performed, the power allocation is performed based on a power allocation algorithm, and the scheduling and the power allocation are repeated until an entire algorithm converges to a final value, and
when the scheduling is performed based on the auction-based algorithm, the AP transmits bidding information determined based on a power amount allocated for the UE and leakage amount information derived through the SLINR to the UE, the UE acquires bidding information from each of a plurality of APs and determines a set of one or more APs with which to perform communication to perform the scheduling.

6. The operating method of claim 5, wherein, when a set of UEs supported by the AP is determined based on the scheduling, the AP performs the power allocation to maximize performance of a UE having the lowest performance among one or more UEs included in the set of UEs.

7. The operating method of claim 6, wherein the scheduling and the power allocation are repeated until performance of the UE having the lowest performance converges to the final value at which the performance is maximized based on the entire algorithm.

8. An operating method of a user equipment (UE) for performing scheduling in a multi-central processing unit (CPU) cell-free network, the operating method comprising:
transmitting a reference signal to an access point (AP), the AP receiving the reference signal from one or more UEs to perform channel estimation, deriving a signal-to-leakage-interference-plus-noise-ratio (SLINR) for each of the one or more UEs based on the channel estimation, and performing scheduling and power allocation based on the derived SLINR;
receiving bidding information from each of one or more APs including the AP when the scheduling is performed by the AP; and
determining an AP set with which to perform communication based on the bidding information received from each of the one or more APs.

9. The operating method of claim 8, wherein the bidding information is determined based on a power amount allocated for the UE and leakage amount information derived through the SLINR.

10. The operating method of claim 8, wherein the multi-CPU cell-free network includes a plurality of CPUs, one or more APs being connected to each of the plurality of CPUs based on a fronthaul,
when the UE is located in a CPU internal area, the UE communicates with a plurality of APs connected to any one CPU of the plurality of CPUs, and
when the UE is located in a CPU edge area, the UE communicates with a plurality of APs connected to each of the plurality of CPUs.

11. An access point (AP) for performing scheduling and power allocation in a multi-central processing unit (CPU) cell-free network, the AP comprising:
a memory;
a transceiver; and
a controller configured to control the memory and the transceiver,
wherein the controller controls the transceiver to receive a reference signal from one or more user equipments (UEs), performs channel estimation based on the received reference signal, derives a signal-to-leakage-interference-plus-noise-ratio (SLINR) for each of the one or more UEs based on the channel estimation, and performs the scheduling and the power allocation based on the derived SLINR.

12. The AP of claim 11, wherein the multi-CPU cell-free network includes a plurality of CPUs, and one or more APs are connected to each of the plurality of CPUs based on a fronthaul.

13. The AP of claim 12, wherein a UE located in a CPU internal area among the one or more UEs communicates with a plurality of APs connected to any one CPU among the plurality of CPUs, and
a UE located in a CPU edge area among the one or more UEs communicates with a plurality of APs connected to each of the plurality of CPUs.

14. The AP of claim 11, wherein the AP performs initial scheduling and initial power allocation through the derived SLINR, and
when the initial scheduling and the initial power allocation are performed, the AP determines an initial scheduling UE set based on a large scale fading coefficient and allocates the same power for each UE in the initial scheduling UE set.

15. The AP of claim 14, wherein the scheduling is performed based on an auction-based algorithm after the initial scheduling and the initial power allocation are performed, the power allocation is performed based on a power allocation algorithm, and the scheduling and the power allocation are repeated until an entire algorithm converges to a final value, and
when the scheduling is performed based on the auction-based algorithm, the AP transmits bidding information determined based on a power amount allocated for the UE and leakage amount information derived through the SLINR to the UE, the UE acquires bidding information from each of a plurality of APs and determines a set of one or more APs with which to perform communication to perform the scheduling.

16. The AP of claim 15, wherein, when a set of UEs supported by the AP is determined based on the scheduling, the AP performs the power allocation to maximize performance of a UE having the lowest performance among one or more UEs included in the set of UEs.

17. The AP of claim 16, wherein the scheduling and the power allocation are repeated until performance of the UE having the lowest performance converges to the final value at which the performance is maximized based on the entire algorithm.

18. A user equipment (UE) for performing scheduling in a multi-central processing unit (CPU) cell-free network, the UE comprising:
a memory;
a transceiver; and
a controller configured to control the memory and the transceiver,
wherein the controller controls the transceiver to transmit a reference signal to an access point (AP), the AP receiving the reference signal from one or more UEs to perform channel estimation, deriving a signal-to-leakage-interference-plus-noise-ratio (SLINR) for each of the one or more UEs based on the channel estimation, and performing the scheduling and power allocation based on the derived SLINR, controls the transceiver to receive bidding information from each of one or more APs including the AP when the scheduling is performed by the AP, and determines an AP set with which to perform communication based on the bidding information received from each of the one or more APs.

19. The UE of claim 18, wherein the bidding information is determined based on a power amount allocated for the UE and leakage amount information derived through the SLINR.

20. The UE of claim 18, wherein the multi-CPU cell-free network includes a plurality of CPUs, one or more APs being connected to each of the plurality of CPUs based on a fronthaul,
when the UE is located in a CPU internal area, the UE communicates with a plurality of APs connected to any one CPU of the plurality of CPUs, and
when the UE is located in a CPU edge area, the UE communicates with a plurality of APs connected to each of the plurality of CPUs.
